(19) United States
(12) Patent Application Publication
(10) Pub. No.: US 2013/0063376 A1
(43) Pub. Date: Mar. 14, 2013

(54) INTERACTIVE DISPLAY SURFACE FOR MULTI-DISPLAY USE

(71) Applicant: Andrew Oakley, Lancashire (GB)

(72) Inventor: Andrew Oakley, Lancashire (GB)

(73) Assignee: PROMETHEAN LIMITED, Lancashire (GB)

(21) Appl. No.: 13/579,084

(22) PCT Filed: Feb. 15, 2011
(86) PCT No.: PCT/EP2011/052227

§ 371 Date: Nov. 28, 2012

(30) Foreign Application Priority Data
Feb. 16, 2010 (GB) 1002644.1

(51) Int. Cl. G06F 3/041

(52) U.S. Cl. 345/173

(57) ABSTRACT

There is disclosed a method of controlling an interactive display system comprising an interactive display surface, the interactive display surface being adapted to detect contact points at said surface, the method comprising: rendering a plurality of images for display on a respective portion of the interactive display surface; routing data associated with a contact point at said surface to the image rendering device associated with the rendering of an image in the portion of the display in which the contact point is detected.

### BACKGROUND TO THE INVENTION

1. Field of the Invention

The present invention relates to an interactive display system comprising an interactive display surface, in which system graphical images are generated for display on the interactive display surface, and the interactive display surface detects contact points thereon coincident with the displayed graphical images.

2. Description of the Related Art

A typical example of an interactive display system is an electronic whiteboard system. An electronic whiteboard system typically is adapted to sense the position of a pointing device or pointer relative to a work surface (the display surface) of the whiteboard, the work surface being an interactive surface. When an image is displayed on the work surface of the whiteboard, and its position calibrated, the pointer can be used in the same way as a computer mouse to manipulate objects on the display by moving a pointer over the surface of the whiteboard.

A typical construction of an electronic whiteboard system comprises an interactive display forming the electronic whiteboard, a projector for projecting images onto the display, and a computer system in communication with the electronic whiteboard for generating the images for projection, running software applications associated with such images, and for processing data received from the display associated with pointer activity, such as the location of a pointer on the display surface, and a condition of the pointer (such as a switch state). In this way the computer system can control the generation of images to take into account the detected movement and action of the pointer on the interactive surface.

Interactive display systems, and in particular electronic whiteboard systems, are quite typically provided with large scale interactive work surfaces. In the prior art, such interactive work surfaces are associated with a single graphics display originating from a single computer.

It is an aim of the present invention to provide an improved interactive display system, in particular an interactive display system in which an interactive display surface is utilised in a versatile way.

### SUMMARY OF THE INVENTION

In accordance with the invention there is provided an interactive display system comprising: an interactive display surface, the interactive display surface being adapted to detect contact points at said surface; a plurality of image rendering devices, each for rendering at least one image for display on a respective portion of the interactive display surface; a controller for routing data associated with a contact point at said surface to the image generator associated with the generation of an image in an area of the display in which the contact point is detected.

The plurality of image rendering devices may include a plurality of graphics drivers, each generating the respective at least one image for display.

The image rendering devices may include a computing device and a graphics driver.

The controller may be adapted to route data associated with a contact point at said surface to the computing device associated with the generation of an image in an area of the display in which the contact point is detected, which image is displayed on the interactive surface by the associated graphics driver under the control of the computing device.

A plurality of rendering devices may include a plurality of graphic drivers and a single computing device.

The image rendering device may includes a projector for projecting an image to the interactive display surface. The image rendering device may include a driver for an emissive interactive display surface.

A plurality of image rendering devices may render an image for a display in non-overlapping portions of the display. A plurality of image generators may generate images in portions of the display which overlap at least in part.

In accordance with the invention there is provided an interactive display surface adapted to detect contact points at said surface and for the display thereon of a plurality of images on respective portions of the interactive display surface, the interactive display surface further being adapted to route data associated with a contact point at said surface to an image rendering device associated with the generation of an image in an area of the display in which the contact point is detected.

The interactive display surface may comprise a surface for the display of projected images, and in which the image rendering devices include image projector device.

The interactive display surface may comprising an emissive display surface, and in which the image rendering devices include emissive display interfaces.

The invention provides a computer system for an interactive display surface adapted to detect contact points at said surface and for the display thereon of a plurality of images on respective portions of the interactive display surface, the computer system being adapted to route data associated with a contact point at said surface to an image rendering device associated with the rendering of an image in an area of the display in which the contact point is detected.

The invention provides an interactive display surface including such a computer system.

The invention provides an interactive display system including an interactive display surface and such a computer system.

The interactive display system may further include a plurality of further computer systems, each of the plurality of further computer systems including an image rendering device.

The invention provides a method of controlling an interactive display system comprising an interactive display surface, the interactive display surface being adapted to detect contact points at said surface, the method comprising: rendering a plurality of images for display on a respective portion of the interactive display surface; routing data associated with a contact point at said surface to the image rendering device associated with the rendering of an image in the portion of the display in which the contact point is detected.

The method may further comprise providing a plurality of image rendering devices to render images for display in non-overlapping portions of the display. The method may further provide a plurality of image rendering devices to render images for display in portions of the display which overlap at least in part. The step of rendering a plurality of images may comprise projecting a plurality of images.

### BRIEF DESCRIPTION OF THE FIGURES

The invention will now be described by way of example with reference to the accompanying figures, in which:

FIG. 1 illustrates the main elements of an interactive display system in accordance with an embodiment of the invention;

FIG. 2 illustrates the functional elements of the interactive display system of FIG. 1 in accordance with an embodiment of the invention;

FIG. 3 illustrates the functional elements of a user computer in a described embodiment;

FIG. 4 illustrates the functional elements of a host computer in a described embodiment;

FIG. 5 illustrates the process of registering a user computer in a described embodiment;

FIG. 6 illustrates the process of registering a user computer in another described embodiment; and

FIG. 7 illustrates the generation of a code in the process of FIG. 6.

### DESCRIPTION OF THE PREFERRED EMBODIMENTS

The invention is now described by way of reference to various examples, embodiments, and advantageous applications. One skilled in the art will appreciate that the invention is not limited to the details of any described example, embodiment or detail. In particular the invention is described with reference to an exemplary interactive display system. One skilled in the art will appreciate that the principles of the invention are not limited to such a described system.

Embodiments of the invention are, in particular, described in the context of an interactive display system incorporating a projection system, where a projector projects graphical images onto an interactive surface. The invention is not however limited to such an implementation.

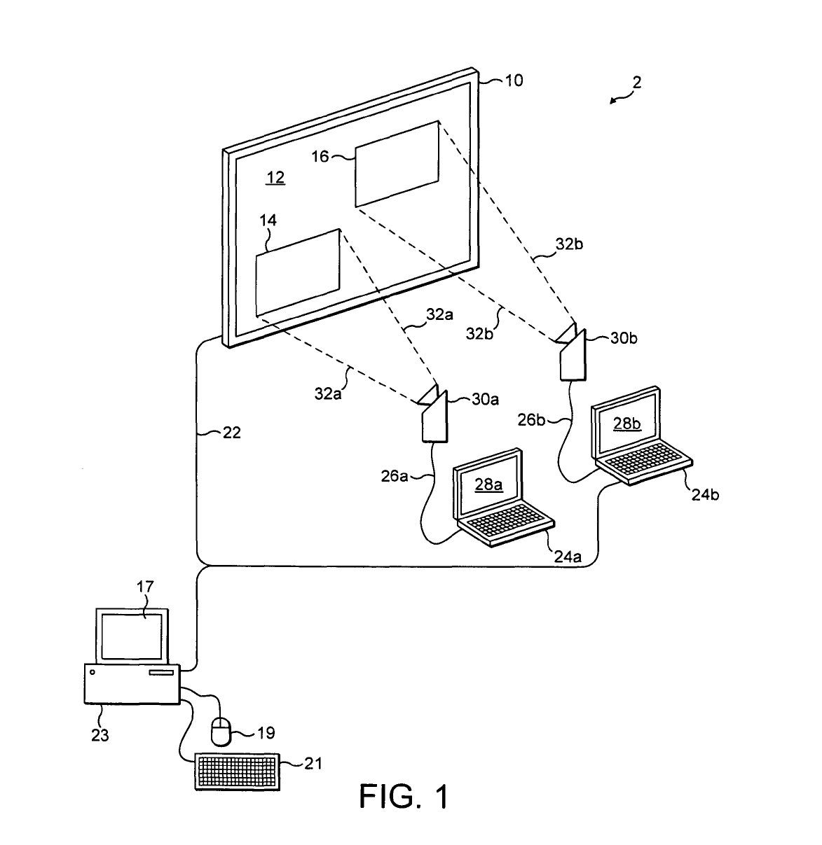

With reference to FIG. 1, there is generally illustrated an interactive display system in accordance with an embodiment of the invention, generally denoted by reference numeral 2. The interactive display system includes an interactive whiteboard 10, incorporating an interactive display surface 12. The interactive display system further includes a host computer 23, and in the described embodiment still further includes two user computers denoted by reference numerals 24a and 24b. Each user computer 24a and 24b is associated with respective display rendering devices denoted by reference numerals 30a and 30b.

In general, the interactive display system 2 may include one or more user computers 24 and respective display rendering devices 30. Although in the exemplary arrangement of FIG. 1 the display rendering devices are shown as separate to the user computers, in alternative arrangements the display rendering devices may be integrated within the user computers.

The host computer 23 controls the operation of the interactive display system 2. Whilst the host computer 23 is illustrated in the exemplary arrangement of FIG. 1 as a distinct computer system, in alternative arrangements the functionality of the host computer may be integrated within the electronic whiteboard 10, or one of the user computer devices may provide the host computer functionality.

In FIG. 1, a communication link 22 is illustrated, interconnecting the electronic whiteboard 10, the host computer 23, and the user computers 24a and 24b. This communication link 22 represents the interconnection of these elements to support any necessary communication, as described below. In practice, the elements of the system may communicate wirelessly, and the communication link 22 is therefore not necessarily a physical or dedicated link.

The electronic whiteboard 10 outputs data, representative of inputs detected at the interactive display surface 12, as so-called board data as known in the art. In the preferred arrangement of the interactive display system 2, and as is known in conventional interactive display systems, the board data is transmitted by the electronic whiteboard 10 to the host computer 23. Illustratively this communication is achieved on the communication link 22; in practice the communication may be achieved wirelessly.

As illustrated in FIG. 1 the host computer may have an associated computer display 17, and input devices including a mouse 19 and a keyboard 21. The host computer 23 may control a display rendering device, such as a projector, for displaying images on the interactive surface 12, as known in the art. However this is not essential for the implementation of the invention and is not shown in the arrangement of FIG. 1.

Each of the user computers 24a and 24b may be any type of computing device including desktop computers, laptop computers, and hand-held computing devices such as personal digital assistants (PDAs) or telephony devices. In a described embodiment, each user computer is adapted to receive board data from the host computer 23, illustratively on the communication link 22; in practice preferably wirelessly. Each user computer 24a and 24b is also adapted to provide respective output signals on respective output lines 26a and 26b, to provide inputs to the respective display rendering devices 30a and 30b. The user computers 24a and 24b may also include respective displays 28a and 28b associated therewith.

Each of the user computer devices 24a and 24b is adapted to generate graphical images associated with an application running on the respective user computer device. These graphical images are communicated on output lines 26a and 26b and displayed to the projected areas 14 and 16 by the respective display rendering devices 30a or 30b.

The display rendering devices 30a and 30b are, in the described embodiment of the invention, projector devices. The display rendering devices 30a and 30b project images onto the interactive display surface 12 under the control of the respective user computers. As can be seen illustratively in FIG. 1, the display rendering devices 30a displays images onto an area 14 of the interactive display surface 12 defining a projected area. The display rendering device 30b projects images onto an area 16 of the interactive display surface 12 defining another projected area. The dash lines 32a illustrate projection of the images from the display rendering device 30a to the projected area 14; the dash lines 32b represent the projection of the displayed images from the display rendering device 30b to the projected area 16.

In accordance with this described embodiment of the invention, both user computer systems 24a and 24b thus project images associated with the applications running thereon onto the interactive display surface 12 in the respective projected areas 14 and 16. As such, each user computer system displays images on a part of the interactive display surface, associated with applications running thereon, and effectively acts as a conventional host computer for a particular projected area on the interactive display surface, as will be described further hereinbelow.

As will be discussed further hereinbelow, the interactive display system 2 is adapted to deliver board data associated with contact points detected on the interactive display surface 12 within any projected area (such as areas 14 and 16) to the respective user computer associated with that projected area (such as user computers 24a and 24b), for control of the applications running on the respective user computers. The mechanism for delivering board data to a user computer may vary, and an example is described herein.

In the embodiment illustrated in FIG. 1, each of the computers 24a and 24b is a computer system which runs independently of the other. Although two computer systems generating two sets of displayed images onto the interactive display surface 12 are illustrated in FIG. 1, in practice in accordance with the principles of the invention two or more sets of graphical images may be generated for display on the interactive display surface 12.

Each user computer system preferably generates graphic display output data, such as VGA data.

In the embodiment as illustrated in FIG. 1, each computer system 24a and 24b thus provides a display output which is visible on the interactive display surface 12 in non-overlapping projected areas 14 and 16. However the invention is not limited to the projected areas being non-overlapping. In alternative embodiments, two or more projected areas may overlap, partially or fully.

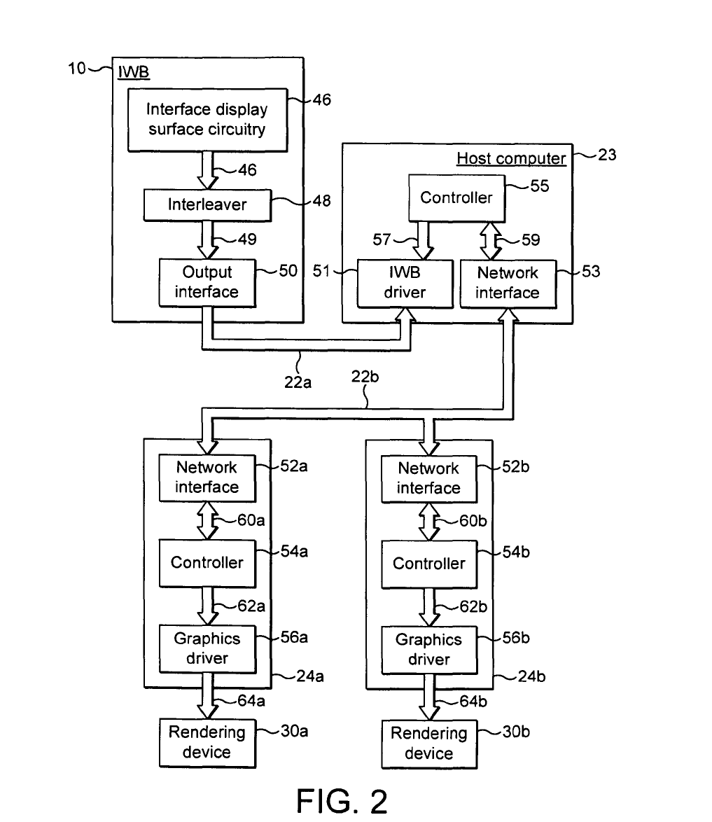

With reference to FIG. 2, the described embodiment of the invention is further discussed with reference to the functional elements of the interactive whiteboard 10, the host computer 23 and the respective user computers 24a and 24b.

As illustrated in FIG. 2, the interactive whiteboard 10 incorporates the interactive surface, the functional elements thereof being denoted by reference numeral 46. The functional elements 46 of the interactive surface comprise the interactive surface 12 itself and electronic circuitry associated with the operation of the interactive surface as known in the art. The interactive whiteboard 10 is further illustrated to include an interleaver/multiplexer 48, and an output interface 50.

In the described arrangement, the electronic whiteboard 10 is a known whiteboard, and is not specially adapted to facilitate any aspect of the invention. The interactive display surface circuitry 46 detects contact points on the interactive surface, and determines co-ordinates associated therewith, using conventional techniques for the relevant interactive surface technology. Multiple simultaneous contact points may be detected on the interactive surface, and the interleaver 48 interleaves the contact point data for delivery to the output interface as board data in a conventional manner. The output interface transmits the board data, on communication link 22a, to the host computer 23.

As illustrated in FIG. 2, the host computer 23 includes a controller 55, an interactive whiteboard (IWB) driver 51, and a network interface 53. The interactive whiteboard driver 51 receives the board data on the communication link 22a from the electronic whiteboard 10. The interactive whiteboard driver 51 delivers the received board data on a communication link 57 to the controller 55. The controller 55 receives and transmits data on a bi-directional communication link 59 to the network interface 53. The network interface 53 is connected to the communication link 22b, for transmitting and receiving data to and from the user computer devices, such as computer device 24a and 24b.

As will be discussed further hereinbelow, in accordance with the preferred embodiment described herein the host computer 23 is adapted to process the board data received from the electronic whiteboard 10 and in accordance with the physical area of the interactive surface at which board data is received, forward such board data to the appropriate user computer system having a graphical display in that area of the interactive display surface. Further, the host computer 23 is adapted to control the registration of user computer devices with the interactive display surface. The host computer 23 is also adapted to control the calibration of user computer devices with the interactive display surface. The operation of the host computer 23 in accordance with preferred embodiments of the invention is described further hereinbelow.

Each user computer 24a, 24b respectively includes a network interface 52a, 52b, a controller 54a, 54b, and a graphics driver 56a, 56b.

Each user computer 24a and 24b is connected to receive and transmit data on the communication lines 22b. As will be described further hereinbelow, the host computer 23 is adapted to transmit to each of the user computers 24a, 24b board data which is associated with the projected area for the respective user computers. Thus the user computer 24a receives board data associated with projected area 14. The network interface 52a, 52b of each computer 24a, 24b is thus adapted to receive the board data on the communication link 22b associated with the computer's respective projected area. The network interfaces 52a, 52b of the user computers may be interactive whiteboard drivers.

Each user computer 24a, 24b is thus preferably adapted to receive from the host computer 23 data associated with its own projected display area 14 or 16. Thus the board data on the communication link 22b is preferably provided with identification information which identifies the display area with which it is associated, or alternatively the user computer system with which the display area is associated. In the preferred implementation, the network interfaces 52a, 52b are adapted to only process data received on the communication link 22b which contains identifiers associated with the respective computer system or its associated projected area. In an alternative arrangement the network interfaces 52a, 52b may receive all board data from the host computer 23, and forward this for filtering within the user computer itself.

As further denoted in FIG. 2, in accordance with the described embodiment of the invention the network interfaces 52a, 52b forward the data received on the communication link 22b on an internal data bus 60a, 60b respectively to the controllers 54a, 54b.

The controllers 54a, 54b operate to process the data in accordance with an operating system of the user computer, to control or update the application running on the user computer which is associated with the displayed image in accordance with conventional techniques.

The controllers 54a, 54b then generate data on data buses 62a, 62b respectively which form inputs to the graphics drivers 56a, 56b respectively. The graphics drivers 56a, 56b respectively deliver graphics data on graphics data buses 64a, 64b respectively to the respective rendering devices 30a, 30b.

As illustrated in FIG. 1, in the exemplary arrangement the respective rendering devices 30a, 30b, which preferably comprise projector devices, are external to the computers 24a and 24b, and render a displayed image to the interactive display surface 12 in either the projected display area 14 or 16.

The operation of the interactive display system 2 in accordance with an embodiment of the invention is now further described, firstly with reference to the procedure by which a user computer, such as computers 24a, 24b, registers with the electronic whiteboard 10. As discussed hereinabove, in a preferred arrangement the elements of the interactive display system 2, such as the user computer devices 24a, 24b, are wirelessly connected to the electronic whiteboard 10. As such, there is a need for a technique for registering a new user computer with the electronic whiteboard in the interactive display system 2.

In an example implementation, registration of a user computer 24 with the electronic whiteboard 10 is achieved via Bluetooth pairing, which techniques are known in the art. In general any standard communication interface/protocol may be used to register a user computer with the interactive surface.

In the described arrangement, where the host computer 23 is associated with the interactive whiteboard 10, for the purposes of a described example it is assumed that the Bluetooth pairing on behalf of the electronic whiteboard 10 is achieved under the control of the host computer 23. The host computer 23 is a computer which is already registered with the electronic whiteboard 10, via wireless means or otherwise, utilising conventional wired or wireless registration techniques. Thereafter, one or more user computing devices, such as computer devices 24a, 24b, may register with the electronic whiteboard 10 in order to utilise the interactive display surface 12 thereof.

The host computer 23 is controlled by the controller 55 to be in Bluetooth ‘discoverable’ mode. The user computing device 24a, for example, is set into Bluetooth ‘discovery’ mode. Following standard Bluetooth communication techniques, all Bluetooth devices in discoverable mode, and within range of the user computer 24a, are then displayed on the display 28a of the user computer 24a. If the user computer device does not have an integrated display then the list of Bluetooth devices discovered may be displayed in the projected area 14 on the interactive display surface 12, using the image rendering device 30a connected to the computer device 24a. Alternatively the list of devices may be displayed both on the integrated display 28a and projected onto the projected display area 14. Preferably the Bluetooth identity of the electronic whiteboard 10 is physically presented on the electronic whiteboard 10, for example along one of its edges, or on an integrated electronic display. Thus from the list of selected display devices the user computer 24a may be controlled to select the specific electronic whiteboard 10 of interest. The selection of the device from a displayed list is via the user interface of the user computer 24a, as the display to the interactive surface is not yet registered/calibrated and cannot be selected at the interactive surface.

Thereafter the Bluetooth pairing is completed such that the user computer 24a is registered with the electronic whiteboard 10 via the host computer 23. The necessary communications to achieve this Bluetooth pairing are preferably between the host computer 23 and the computing device 24 using the communication link 22b, which is preferably a wireless communication link. One skilled in the art will fully appreciate the techniques involved in Bluetooth pairing of two devices, and these techniques are not described in any detail herein. The invention is not concerned with the mechanism by which the user computer is registered with the host computer (on behalf of the electronic whiteboard). Although an example is given where Bluetooth pairing is used, in practice any technique for allowing registration between a user computer device and a host computer device, whether wireless or otherwise, may be utilised in accordance with the principles of the invention.

Once a user computer device is registered with the host computer device 23, the host computer 23 retains the identity of the user computer device, and the communication between the electronic whiteboard and the user computer device is via the host computer 23.

The registration of user devices may be directly with the electronic whiteboard 10, rather than the host computer 23. In such scenario the registration functionality provided by the host computer 23, as described above, is provided by the electronic whiteboard 10 itself.

In alternative arrangements, the registration of a user computer device with the electronic whiteboard may be achieved in other ways, including via an integrated process which also allows for the projected display of the user computer device to be calibrated with the interactive display surface.

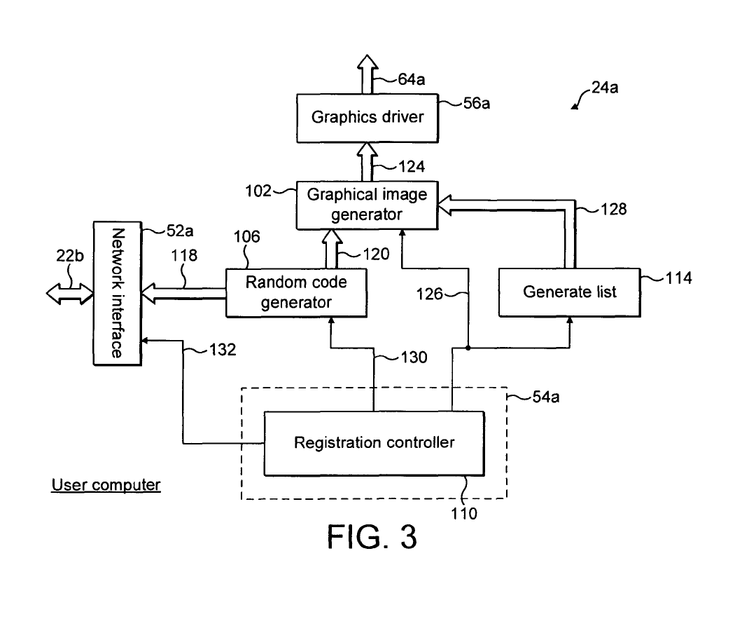

With reference to FIG. 3, there is illustrated the main functional components of a user computer device 100, such as user computer devices 24a, 24b, for implementing the main features of the present invention. One skilled in the art will appreciate that a user computer device such as that illustrated in FIG. 3 will require further functional elements for full operation.

The user computer 24a includes the network interface 52a, the graphics driver 56a, and the controller 54a including a registration controller 110. The user computer 24a further includes a graphical image generator 102, a random code generator 106, and a generate list entity 114. The random code generator 106, and the generate list entity 114 are controlled by the registration controller 110 on control signal lines 130 and 126 respectively. The graphical image generator 102 is additionally controlled by the registration controller 110 on control line 126. The random code generator 106 generates data on data bus 118 to the network interface 52a, and data on data bus 120 to the graphical image generator 102. The generate list entity 114 generates data on a data bus 128 to the graphical image generator 102. The graphical image generator 102 generates graphical image data on data bus 124 to the graphics driver 56a, which in turn generates graphics data on communication link 64a to the rendering device.

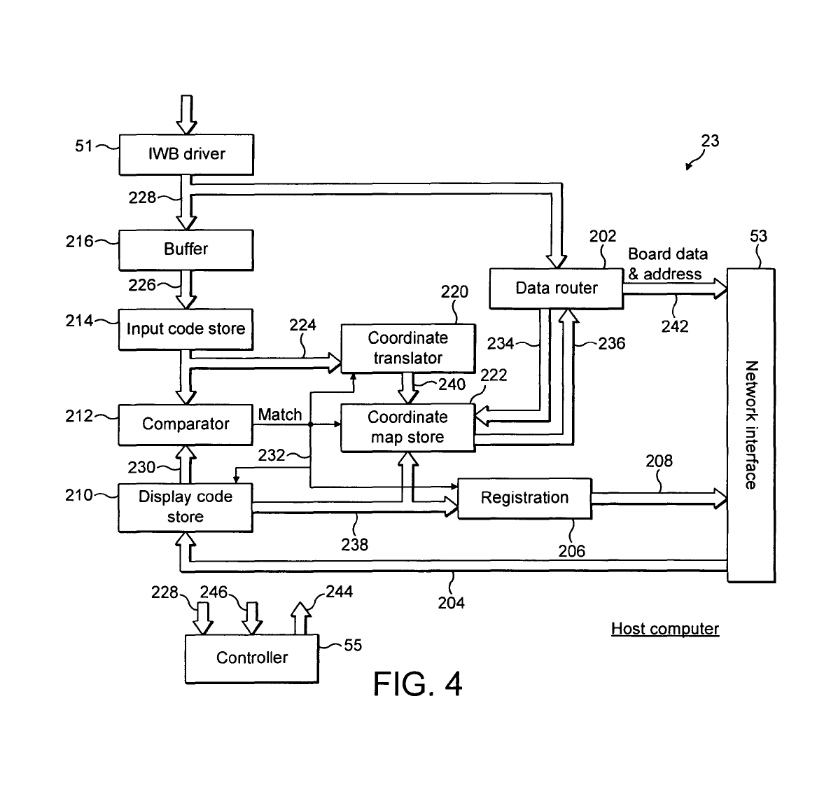

With reference to FIG. 4 there is illustrated the main functional elements of the host computer 23. Additional functional elements are required for the full operation of the host computer 23, and only those elements are illustrated which are necessary for understanding the present invention.

The host computer 23 includes the interactive whiteboard driver 51, the network interface 53, and the controller 55. Additionally the host computer includes a buffer 216, an input code store 214, a comparator 212, a display code store 210, a coordinate map store 222, a coordinate translator 220, a registration entity 206, and a data router 202. The interactive whiteboard driver 51 provides the received board data on data bus 228 to the buffer 216 and data router 202. The buffer 216 provides data on data bus 226 to the input code store 214. The input code store 214 provides data on data bus 224 to the comparator 212 and the coordinate translator 220. The coordinate translator 220 provides data on data bus 240 to the coordinate map store 222. The display code store 210 receives data on a data bus 204 from the network interface 53, and provides data on a data bus 230 to the comparator 212. The display code store 210 also provides data on data bus 238 to the registration entity 206 and the coordinate map store 222. The comparator 212 generates a control signal, MATCH, on line 232 to each of the coordinate translator 220, the coordinate map store 222, the display code store 210, and the registration entity 206. The coordinate map store 222 generates data on data bus 236 to the data router 202, and receives data on data bus 234 from the data router 202. The data router 202 generates board data and addresses on bus 242 to the network interface 53. The registration entity 206 generates data on data bus 208 to the network interface 53.

In FIG. 4 the controller 55 is generally illustrated as generating control signals 244, and receiving control signals 246, and receiving the board data on bus 228. The controller may incorporate one or more of the other functional elements illustrated in FIG. 4.

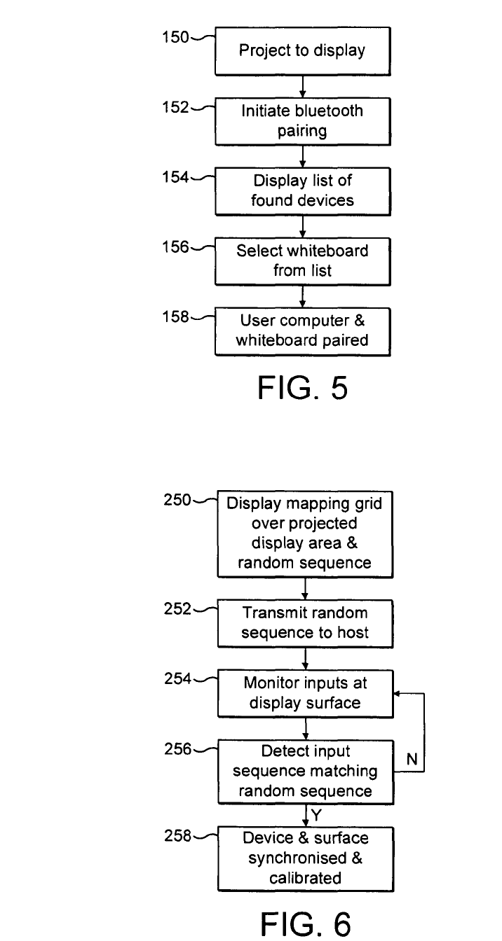

The operation of the interactive display system 2 of FIG. 1 in registration, calibration, and operational phases is now further described with reference to FIGS. 3 and 4, and the flow diagrams of FIGS. 5 and 6.

With reference to FIG. 5, in a step 150 the user computer 24a is controlled to project to the interactive display surface 12. Thus the registration controller 110 sets the control signal 126, such that the graphical image generator 102 presents an image associated with data on data bus 124 to the graphics driver 56a. In practice, this may simply be a blank display.

In a step 152 the user computer then initiates Bluetooth pairing. Thus the registration controller 110 communicates with the network interface 52a on line 132, to implement standard Bluetooth communications as known in the art.

The registration controller 110 then receives via the network interface 52a on communication line 132 details of discoverable Bluetooth devices which have been found. In step 154 a list of found devices is then displayed, by the registration controller 110 controlling the generate list entity 114 using control line 126. An appropriate list is then provided on data bus 128 to the graphical image generator 102, the appropriate graphical image then presented on data bus 124 to the graphics driver 56a and displayed in the projected area 14 on the interactive display surface 12.

In a step 156, the device being the electronic whiteboard is selected from the displayed list. The registration controller 110 transmits appropriate signals via the network interface 52a to communicate this selection.

Thereafter in step 158 the user computer and the electronic whiteboard 10 are paired as Bluetooth devices.

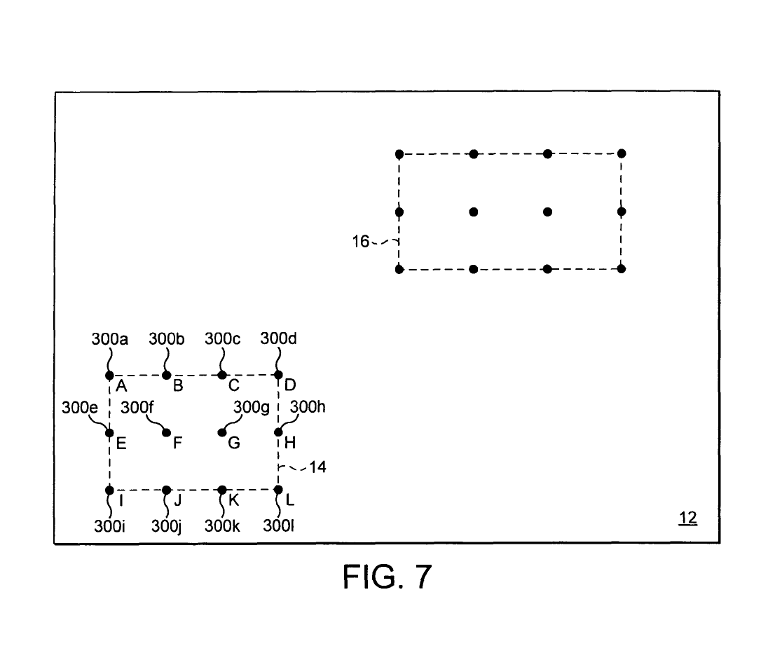

With reference to FIGS. 6 and 7, there is illustrated a preferred process for mapping the projected area on the interactive display surface 12, and calibrating the projected image.

The registration controller 110 is adapted to generate a random code using the random code generator 106 under the control of the control signal on line 130. In the preferred embodiment, the random code is a sequence associated with a preconfigured display pattern. An example preconfigured display pattern is illustrated in FIG. 7.

As can be seen in FIG. 7, each of the projected areas and 16 is shown to include a mapping grid comprising a sequence of points. The number of points, and the location, will be implementation dependent. In the arrangement shown in FIG. 6, the mapping grid includes 12 points. The first 10 points - denoted by reference numerals 300a to 300e, 300h, and 300i to 300l—are displayed on the perimeter of the projected area. The two further points 300f and 300g are projected within the projected area. The points are labelled A to L in FIG. 7: A=300a; B=300b; C=300c; D=300d; E=300e; F=300f; G=300g; H=300h; I=300i; J=300j; K=300k; and L=300l. The position of the various points is predefined and fixed. The relative spacing of the points will vary according to the size of the projected image, which will be determined by the distance of the rendering device from the interactive display. In the preferred arrangement a mapping point is provided at each corner of the displayed image, in the example of FIG. 7 the mapping points 300a, 300d, 300l, 300i being the corner points.

In the preferred arrangement of the invention, in order to map the displayed image to the interactive surface, a user is always required to provide a contact point at each of the four corners in sequence. Thereafter the random code generator 106 generates four random points which must be additionally contacted. These points provide a unique sequence to register a particular device.

In the preferred example, therefore, the random code generator 106 generates a code sequence of eight contact points, from the contact points A to L. The first four contact points are fixed, and are the contact points A, D, L, I. By selecting these contact points, the host computer is able to identify the bounding area of the projected area. The next four points are selected randomly from the available points, to define a unique code.

With reference to FIG. 6, in the step 250, the appropriate display is displayed in the projected area based on the random code generated by providing the necessary information on communication lines 120 to the graphical image generator 102.

In addition to displaying the image of FIG. 7, there is displayed the unique sequence to be used by the user for calibration.

With reference to FIG. 6, in a step 252 the random code generated by the random code generator 106 is also provided on the data bus 118 to the network interface 52a, where it is transmitted to the host computer. The host computer receives the code at the network interface 53, and is delivered on interface bus 204 to the display code store 210.

The host computer 23 then buffers board data received by the interactive whiteboard driver 51 and provided on a data bus 228. As eight contact points are required in order to detect a code sequence, once eight contact points have been buffered into the buffer 216, these contact points are provided on the interface 226 to the input code store 214. The contents of the input code store 214 are then provided on bus 224 to provide one set of inputs to the comparator 212, the other set of inputs to the comparator 212 being the stored code in block 210 provided on bus 230.

The contact points detected on the interactive surface during this phase of operation are expected to be a sequence of contact points corresponding to the unique sequence displayed to the user on the display.

In a step 256, the comparator 212 then determines whether an input sequence matching the generated random sequence is detected. If not, then the inputs at the interactive display surface are continued to be monitored in step 254.

In the event that a match is detected in the comparator 212, then the match control signal on line 232 is set.

Responsive to this signal, the registration entity 206 generates a registration acknowledgement signal on lines 208 which is transmitted via the network interface 53 to the network interface 52a of the user computer. On receipt of this signal, the registration controller 110 of the user computer sets control signals on line 130 to disable the random code generator 106 as registration and calibration are now complete.

At the host computer, the match signal on line 232 causes the identity of the user device, which is stored in the display code store 210 together with the display code, to be entered into the coordinate map store together with the coordinates for the projected area 14 which are provided by the coordinate translator 220 on line 240 from the input information received.

Thus as denoted by step 258, the user computer and the interactive surface are synchronised and calibrated.

Whilst in the described embodiment the random number generation is described as being implemented in the user computers, once registration is established the random number generation may take place in the host computer. The random number may be provided by the host computer to a user computer.

Thereafter, in routine operation, board data is provided to the data router 202 from data bus 228. The coordinate information associated with received board data is mapped to a user computer by provision on lines 234 to the coordinate map store 222, which returns a user computer device identity on lines 236. The data router 202 then outputs the board data with an associated address or user computer identity on lines 242, for transmission via the network interface 53 to the appropriate user computer device.

Thus tagged data packets are delivered to the network, for delivery to the appropriate user computer. The independent point contact data from each display area is thus re-directed to its associated user computer system via a suitable communication means.

The interactive whiteboard 10 is thus calibrated in such a way that the location, size and orientation of each projected display area 14 and 16 associated with the respective user computers 24a and 24b is known with respect to the interactive display surface 12.

In the embodiment described herein, the graphic output from each computer is projected onto a small, non-overlapping area of a single interactive display surface 12. Each projected display area is calibrated using either a single pointing input device, or multiple pointing input devices.

In the preferred embodiment the interactive display surface 12 is an electromagnetic surface, and inputs at such surface are detected responsive to the presence of a pointing device including a tuned circuit which is adapted to respond to an excitation signal from the interactive display surface 12. In such an arrangement, a specific pointing device may be associated with each of the different projected display areas such as areas 14 and 16. This may be achieved, as is known in the art, by associating a different excitation frequency with different pointing devices.

Coordinate data and control data, such as the state of switches of the pointing devices, is then generated by the interactive whiteboard 10 for each calibrated area as and when a designated pointing device interacts with its associated projected display area. Data from each projected area may then be sent as a single coordinate stream to the user computer with which the user input device is associated, using standard networking protocols without the need for location mapping as described hereinabove.

Each user computer system 24a preferably receives input data from the interactive whiteboard 10 as conventional board data, and is unaware of coordinate data for other user computers using the shared interactive display surface 12.

In the described embodiment, there is illustrated two distinct user computers for generating two projected displays. In an alternative, a single computer provided with a twin-headed graphics card, and configured to extend the desktop of the operating system onto two monitor outputs, may be used. In such an arrangement the projected images associated with both monitor outputs may be displayed onto respective distinct areas of the interactive display surface 12, thereby increasing the effective resolution of the combined projected display. In such an arrangement the two projected images may preferably be displayed adjacent to each other so as to form a single contiguous display work area. Such arrangement is not limited to a computer comprising a twin-headed graphics card, and may be extended to a multi-headed graphics card and an associated multi-display generation.

The invention is also not limited to an interactive whiteboard arrangement. In general, the invention relates to an interactive surface, which interactive surface may be disposed in any manner or form part of any system implementation. An interactive surface in accordance with the invention and its embodiments may be provided, for example, as a surface of a horizontally disposed apparatus, such as a table top. Display data may be projected down onto the interactive display surface. An individual computing device and its associated projection display area may be registered with a system controlling the interactive display surface 12, and calibrated to the interactive display surface. Contact data detected at the interactive display surface and coincident with the registered projected display area will then be sent to the relevant user computer device.

In such an arrangement where the interactive display surface 12 is formed as a table top arrangement, the image rendering devices 30a or 30b may be implemented as pico projection devices. Such pico projection devices may be incorporated in a single housing with an associated computing device. An example of such a device is a mobile telephone device including a pico projector, which in combination provides the functionality equivalent to the computer 24a and the image rendering device 30a, for example. Such a mobile telephone device may be placed on a ‘table-top’ interactive surface and an associated projection means—preferably an integrated projection means—orientated to project a displayed image onto a part of the interactive surface.

Although in the embodiment described herein the projected areas 14 and 16 are shown to be in independent and distinct regions of the interactive display surface 12, in alternative embodiments the projected areas may overlap. Where the projected areas overlap, interactive surface contact data may be sent to all related computing devices simultaneously. Such an arrangement allows a single contact input on the interactive surface to control two or more systems at the same time. Such control may be control of all or part of such systems.

The projected display may be utilised to have the integrated display of a device. For example, if the device is a mobile telephone with a small display, by projecting the display to the interactive surface a larger version of the image displayed on the device can be provided, which is easier to view and which is easier to interact with.

The invention is further not limited to any specific type of display system. Whilst the invention is described herein with particular reference to the projection of graphical images onto an interactive surface, other types of technologies for controlling the display of images on the interactive surface may be utilised in conjunction with the invention and its embodiments. For example, the interactive surface may incorporate an emissive display surface. The emissive display surface may itself be an interactive surface, adapted to detect one or more inputs at its surface. Alternatively the emissive surface may be provided over or under an interactive surface adapted to detect one or more inputs. In an emissive surface arrangement, the user computing devices are connected to provide graphical output data to the graphics driver(s) of the emissive surface, rather than to projections means.

In general, an image rendering device is provided to render an image for display on the interactive surface. The computing system for generating the images to be rendered, and the device for achieving the rendering of the images, such as a graphics generator, may be consider to comprise the image rendering device. In general an image rendering device generates a set of images for display in a particular portion of the interactive surface, under the control of a computing device. Each image rendering device may be associated with a dedicated computing device, or a single computing device may control a plurality of image rendering devices. For projected images, an image rendering device includes a projector device. For images displayed on an emissive surface, an image rendering devices includes an appropriate interface for interfacing with the emissive surface drivers.

The interactive whiteboard 10 may be provided with a controller (such as a processor) which controls the directing of contact point data from the interactive display surface 12 to the respective computers, such as computers 24a and 24b. That is, the functionality of the host computer may be integrated within the whiteboard.

Alternatively, as illustrated an independent host computer system may be connected to the interactive whiteboard 10, and receive all contact point data detected at the interactive surface 12. Based on knowledge held by the independent host computer system of the relationship between areas on the interactive display surface 12 and associations with computers, the independent computer system may direct the detected contact point data from the interactive display surface 12 to the respective user computers, such as user computers 24a and 24b.

In a further alternative arrangement, rather than providing an independent host computer system, one of the user computers, such as either computer 24a or 24b, may be adapted to receive all contact point data from the interactive display surface 12, and route such data to other computers as appropriate based on knowledge of the relationship between the areas of the interactive display surface 12 and associated user computers. Thus one of the user computers may provide the functionality of the host computer.

In a still further alternative, one of the computer systems, such as computer 24a or computer 24b, may be hosted within the interactive whiteboard 10, which computer system may control the routing of data to appropriate other computers.

The invention has been described herein in the context of application to a particular interactive display system. It will be understood by one skilled in the art that the principles of the invention, and embodiments described herein, are not limited to any specific interactive display system. The principles of the invention and its embodiments may be implemented in any interactive display system, such as an interactive display system incorporating an interactive display surface using electromagnetic technology (as described herein), and also such systems incorporating touch-sensitive technology, or camera technology, for example. The invention is not concerned with the specific arrangement of the interactive display surface, nor the specific arrangement of the input detection technology at the interactive surface, and does not require any modification to existing interactive display surfaces.

The invention has been described herein by way of reference to particular examples and exemplary embodiments. One skilled in the art will appreciate that the invention is not limited to the details of the specific examples and exemplary embodiments set forth. Numerous other embodiments may be envisaged without departing from the scope of the invention, which is defined by the appended claims.

1. An interactive display system comprising:
an interactive display surface, the interactive display surface being adapted to detect contact points at said surface;
a plurality of image rendering devices, each for rendering at least one image for display on a respective portion of the interactive display surface;
a controller for routing data associated with a contact point at said surface to the image generator associated with the generation of an image in an area of the display in which the contact point is detected.

2. The interactive display system of claim 1 wherein the plurality of image rendering devices include a plurality of graphics drivers, each generating the respective at least one image for display.

3. The interactive display system of claim 2 wherein each image rendering device includes a computing device and a graphics driver, and wherein the controller is adapted to route data associated with a contact point at said surface to the computing device associated with the generation of an image in an area of the display in which the contact point is detected, which image is displayed on the interactive surface by the associated graphics driver under the control of the computing device.

4. The interactive display system of claim 3 wherein the controller is adapted to route data associated with a contact point at said surface to the computing device associated with the generation of an image in an area of the display in which the contact point is detected, which image is displayed on the interactive surface by the associated graphics driver under the control of the computing device.

5. The interactive display system of claim 2 wherein a plurality of rendering devices includes a plurality of graphic drivers and a single computing device.

6. The interactive display system of any one of claims 1 to 5 in which the image rendering device includes a projector for projecting an image to the interactive display surface.

7. The interactive display of any one of claims 1 to 5 in which the image rendering device includes a driver for an emissive interactive display surface.

8. The interactive display system of claim 1 in which a plurality of image rendering devices render an image for a display in non-overlapping portions of the display.

9. The interactive display system of claim 1 in which a plurality of image generators generate images in portions of the display which overlap at least in part.

10. An interactive display surface adapted to detect contact points at said surface and for the display thereon of a plurality of images on respective portions of the interactive display surface, the interactive display surface further being adapted to route data associated with a contact point at said surface to a respective image rendering device of one of a plurality of image rendering devices adapted to render at least one image for display on the interactive display surface associated with the generation of an image in an area of the display in which the contact point is detected.

11. The interactive display surface of claim 10, further comprising a surface for the display of projected images, and in which the image rendering devices include image projector device.

12. The interactive display of claim 10 or claim 8 comprising an emissive display surface, and in which the image rendering devices include emissive display interfaces.

13. A computer system for an interactive display surface adapted to detect contact points at said surface and for the display thereon of a plurality of images on respective portions of the interactive display surface, the computer system being adapted to route data associated with a contact point at said surface to a respective image rendering device of one of a plurality of image rendering devices adapted to render at least one image for display on the interactive display surface associated with the rendering of an image in an area of the display in which the contact point is detected.

14. An interactive display surface including a computer system according to claim 13.

15. An interactive display system including an interactive display surface and a computer system according to claim 13.

16. The interactive display system of claim 13 further comprising a plurality of further computer systems, each of the plurality of further computer systems including an image rendering device.

17. A method of controlling an interactive display system comprising an interactive display surface, the interactive display surface being adapted to detect contact points at said surface, the method comprising:
rendering a plurality of images for display on a respective portion of the interactive display surface;
routing data associated with a contact point at said surface to the image rendering device associated with the rendering of an image in the portion of the display in which the contact point is detected.

18. The method of claim 17 comprising providing a plurality of image rendering devices to render images for display in non-overlapping portions of the display.

19. The method of claim 17 providing a plurality of image rendering devices to render images for display in portions of the display which overlap at least in part.

20. The method of claim 17 wherein the step of rendering a plurality of images comprises projecting a plurality of images.

21. A method at an interactive display surface adapted to detect contact points at said surface and for the display thereon of a plurality of images on respective portions of the interactive display surface, the method comprising routing data associated with a contact point at said surface to a respective image rendering device of one of a plurality of image rendering devices adapted to render at least one image for display on the interactive display surface associated with the generation of an image in an area of the display in which the contact point is detected.

22. A method in a computer system for an interactive display surface adapted to detect contact points at said surface and for the display thereon of a plurality of images on respective portions of the interactive display surface, the method comprising routing data associated with a contact point at said surface a respective image rendering device of one of a plurality of image rendering devices adapted to render at least one image for display on the intereactive display surface associated with the rendering of an image in an area of the display in which the contact point is detected.

23. The method according to claim 17 further comprising a computer system and associated hardware and software.

24. The method of claim 17, further comprising a computer program product adapted to store computer program code.
